(19) United States
(12) Patent Application Publication
(10) Pub. No.: US 2009/0323781 A1
(43) Pub. Date: Dec. 31, 2009

(54) METHOD AND EQUIPMENT FOR TRANSMITTING A SIGNAL BY FILTERING IN A MIRROR BAND

(75) Inventors: Herve Milleret, Bourg-La-Reine (FR); Etienne Chevreau, Bourg-La-Reine (FR)

Correspondence Address: ARENT FOX LLP, 1050 CONNECTICUT AVENUE, N.W., SUITE 400, WASHINGTON, DC, 20036, US

(73) Assignee: SPIDCOM TECHNOLOGIES, Bourg-La-Reine (FR)

(21) Appl. No.: 12/440,166

(22) PCT Filed: Sep. 6, 2007
(86) PCT No.: PCT/FR07/01442

§ 371 Date: May 19, 2009

(30) Foreign Application Priority Data
Sep. 6, 2006 (FR) 0607808

(51) Int. Cl. H04L 27/00

(52) U.S. Cl. 375/216; 375/295

(57) ABSTRACT

The invention relates in particular to a method for transmitting an analogue signal in a predetermined frequency band on the basis of an initial digital signal sampled at a sampling frequency, said method comprising in particular a step of modifying the initial analogue signal so as to generate a modified analogue signal having a modified spectrum in said predetermined frequency band. According to the invention, the modifying step comprises a filtering step consisting in selecting said predetermined frequency band from said plurality of mirror frequency bands.

The invention concerns a method of processing a digital or analogue signal, and a device implementing the method.

The origin of the present invention is the problem aimed at increasing the rate of transmitting data via communication means, or media, available to a private individual, in other words via electric wires used for the distribution of energy, coaxial cables used for broadcasting television programmes, a radio network used in particular in WiFi technology and twisted pairs used for fixed telephony.

Digital communications requirements are continually increasing in order to respond to the expectations of the user: computer network, video games, distant connections between multimedia apparatus. Numerous services, such a internet protocol voice (voice on IP), internet access or video on demand are requiring greater and greater transmission rates.

These requirements are making themselves felt both at a provider of services such as those mentioned above, and at a user of these services.

At the service provider, it is always possible to use communications means affording very high rates, such as for example optical fibres.

At the user, it is difficult to replace the media already installed.

It has been found that, on all media, some frequency bands remain available for new applications. For example, on coaxial cable, television programme broadcasts use only frequencies as from 65 MHz or 80 MHz according to the region. The low frequencies are therefore free.

The present invention therefore proposes to use the broad frequency ranges available on the media mentioned above in order to meet the requirement for increasing data transfer rates.

There exist methods for transmitting an analogue signal in a pre-determined frequency band using an initial digital signal sampled at a sampling frequency, said method comprising steps of:
reception of the initial digital signal, said initial digital signal having an initial spectrum in an initial frequency band,
conversion of the initial digital signal into an initial analogue signal,
modification of the initial analogue signal so as to generate a modified analogue signal having a modified spectrum in said predetermined frequency band,
transmission of the modified analogue signal in the predetermined frequency band.

Thus there already exist methods that provide the movement of the data from an initial frequency band to an unused frequency band.

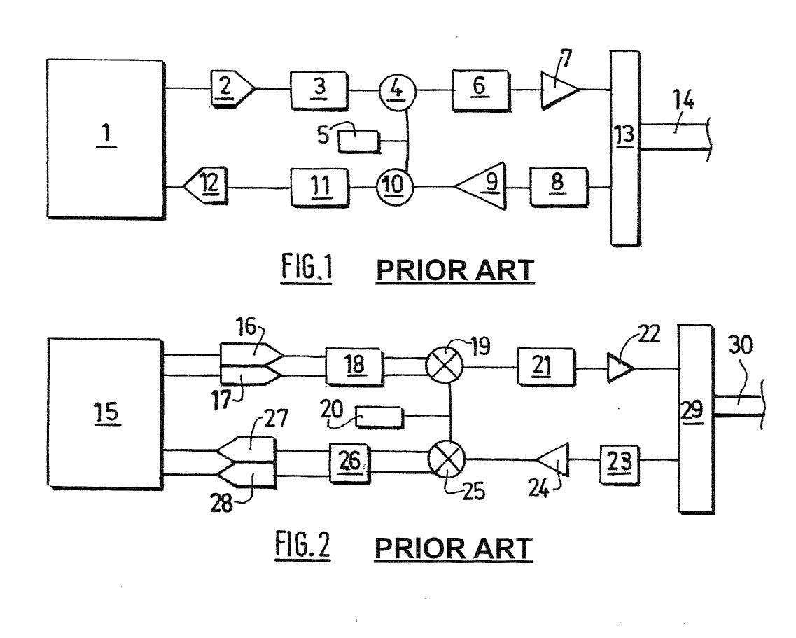

For example, there exists a method using an architecture shown in FIG. 1.

This architecture involves a base-band modem and mixers.

Conventionally, digital communication solutions use a base-band modem capable of processing broad frequency bands of several tens of megahertz, typically up to 30 megahertz. These modems, referred to as “wide-band modems”, are increasingly using OFDM (Orthogonal Frequency Division Multiplexing) techniques.

To send a signal, the OFDM technique divides a frequency range into several sub-channels spaced apart by three bands of fixed sizes. Subsequently, an algorithm (fast Fourier transform) is applied to convey the signal by means of various sub-channels. The algorithm is applied in reverse in order to recompose the signal at the receiver.

As can be seen in FIG. 1, the sending chain of such an architecture is composed of a modem 1, a digital to analogue converter (DAC) 2, a filtering element 3, a mixer 4 associated with a local oscillator 5 representing the carrier frequency, a filtering element 6 and an amplification stage 7.

In this transmission method, the spectrum of the signal to be transmitted is therefore modified by a mixer.

As for the reception chain, this is composed of a unit 8 filtering the incoming signal, an amplification stage 9, a mixer 10 associated with the local oscillator 5, a filtering element 11 and an analogue to digital convertor (ADC) 12 connected to the modem 1.

A coupling element 13 enables the signal to pass through the medium 14.

The way in which the signal is modified by the architecture previously described does however have drawbacks.

This is because, in sending, the function of the mixer not being selective, the resulting mixing products (undesired signals) are liable to interfere with the sensitivity of the equipment or to interfere with the other apparatus connected to the medium. Moreover, this is one of the reasons why filtering is provided after the mixer, this filtering being able to very selective with regard to the degree of contamination of the signal.

In parallel, in reception mode, it is necessary to use filtering after the mixer in order to eliminate any signal outside the band that may interfere with reception.

In addition, in order not to significantly degrade the reception sensitivity of the modem, it is necessary to use a mixer having a low noise factor, that is to say that generates little white noise, so that the mixer does not generate too much interference on the signal received or sent.

Finally, since the local oscillators are not perfect, they create transmission imperfections (CFO: carrier frequency offset) between a sender and a receiver.

These are a particular problem for modulations of the OFDM type mentioned above and must be corrected in the processing of the digital or analogue signal, A specific algorithm for dealing with these imperfections is then necessarily applied.

FIG. 2 shows another architecture for moving the frequency bands to the frequency ranges available on the network.

This is an architecture used in the processing of so-called “complex” signals that have two components I (“In phase”) and Q (“Quadrature”).

This architecture comprises, in a manner that is conventional per se, a modem 15.

In sending mode, the architecture comprises two digital to analogue converters 16 and 17 for each of the components of the complex signal.

It also comprises a filtering element 18, a modulator 19 associated with a local oscillator 20 representing the carrier frequency, a filtering element 21 and an amplification stage 22.

The modulator 19 transforms the two-component complex signal into a real signal. It comprises an input for a signal called local oscillator (LO). The latter signal is the carrier frequency modulated by the complex signal.

On sending, having available the signals I, Q and LO, it is possible to generate a signal in the required frequency band (around 45 MHz for example).

The reception chain is composed of a filtering unit 23, an amplifier 24, a demodulator 25, a filter 16 and two analogue to digital converters 27 and 28.

The demodulator 25 transforms the real signal into a complex signal. It comprises an input for the signal called local oscillator (LO). The incoming real signal is demodulated around the frequency LO. The outgoing signal has two components I and Q.

A coupling element 29 is also provided for the signal to pass into a medium 30.

Such an architecture has the following drawbacks:

In a similar manner to the architecture with a mixer, the modulator 19 and the demodulator 25 generate stray mixing product lines. It is necessary to filter these stray sequences, which are liable to interfere with the sensitivity of the equipment (on reception of signals) and interfere with the other apparatus connected to the medium (when signals are sent).

In addition, it is necessary to use two digital to analogue converters and two analogue to digital converters to process or generate a complex signal, which requires duplicating filtering upstream or downstream of the converters.

Finally, the local oscillator creates CFO (carrier frequency offset) imperfections in transmission between a receiver and a sender, the CFO's being a particular problem, as explained previously, for modulations of the OFDM type. They therefore must absolutely be corrected by applying an algorithm.

The methods of modifying the spectrum of an initial signal in the known transmission methods are therefore not satisfactory.

It is also known that, during a digital to analogue conversion, when a digital signal sampled at an input sampling frequency has a spectrum in a frequency band the upper limit of which is less than half the sampling frequency, the output analogue signal has a spectrum comprising on the one hand the spectrum of the input signal and on the other hand a plurality of mirror frequency bands, said mirror frequency bands being images of said initial frequency band with respect to whole multiples of half the sampling frequency. This phenomenon results in particular from the Shannon-Nyquist sampling theorem and theory, and can be called spectral aliasing.

The document EP-1 569 345 mentions in particular this phenomenon of creating mirror image bands during analogue to digital conversion.

Thus, in the architectures described previously, during analogue to digital conversions, such mirror bands are created. However, persons skilled in the art have always had a tendency to consider that these frequencies should be eliminated, and a low-pass filtering is usually performed in order to regain the initial frequency band in the analogue signal.

Obtaining a signal with a frequency band different from the initial frequency band then requires for example modification methods as described previously.

The document WO-A-00/65722 is also known, which describes a method in which an initial digital signal, having an initial spectrum in an initial frequency band, is received by a supersampler. This supersampler generates a first type of mirror band. The signal having this first type of mirror band is then processed by a processor called Super-Nyquist, and the signal obtained at the output of this Super-Nyquist is transmitted to a digital to analogue converter, which in its turn generates a second type of mirror band. Consequently, at the output from the digital to analogue converter, the mirror bands issue from the combination of the bands generated by the supersampler and by the digital to analogue converter. This combination of mirror bands is then filtered by a filter in order to extract a particular band, and a mixer at the output affords a mixing of frequencies. However, the device described in the publication WO-A-00/65722 has the drawback of requiring the use of a supersampler for generating first mirror bands. This additional processing makes the device more complex. In addition, it requires the use of a mixer since the band selected is not directly usable because of the combination of bands generated by the supersampler and bands generated by the converter.

In addition, the aforementioned document teaches the use of a digital selection of an image frequency coupled to the supersampler in order to produce a mirror signal at a clearly determined frequency where the amplitude at the output from the converter will be maximal. This therefore assumes that the output signal is a signal corresponding to a narrow band, that is to say the bandwidth of this output signal is very small compared with the sampling frequency of the converter. This narrowness of the output bands is also a drawback with the device described in the document WO-A-00/65722.

In the light of this document, one problem solved by the invention is therefore to allow a selection of a specific frequency band while simplifying the device described.

Another problem solved is making it possible to generate signals in a relatively wide band.

The purpose of the invention is in particular to mitigate the drawbacks of the methods described above.

To do this, the invention concerns a method for transmitting an analogue signal in a frequency band predetermined from an initial digital signal sampled at a sampling frequency, said method comprising steps in which:
a digital to analogue converter receives the initial digital signal, said initial digital signal having an initial spectrum in an initial frequency band;
the digital to analogue converter converts the initial digital signal into an initial analogue signal having a spectrum comprising a plurality of mirror frequency bands, said mirror frequency bands being images of said initial frequency band with respect to whole multiples of half the sampling frequency,
the initial analogue signal is modified so as to generate a modified analogue signal having a modified spectrum in said predetermined frequency band,
the modified analogue signal in the predetermined frequency band is transmitted,
   in which the step in which the initial analogue signal is modified comprises a filtering step consisting of filtering said predetermined frequency band among said plurality of mirror frequency bands.

The method according to invention therefore advantageously uses the mirror frequency bands that are generated during an analogue to digital conversion in order to obtain a predetermined frequency band.

Such a predetermined frequency band is therefore achieved without using a mixer, supersampler or modulator as in the complex methods described above. The mirror frequency band being images of said initial frequency band, the information transmitted via the medium is identical or almost identical to that which would have been transmitted if the signal were transmitted via the initial frequency band. In addition, the transmission takes place at a chosen frequency; it thus suffices to use a filter the band width of which corresponds to the frequency range that is a multiple of Fs/2 at which it is wished to transmit the signal.

It is also known that the mirror frequency bands do not have any overlap when the upper limit of the initial frequency band is less than half the sampling frequency of the initial digital signal.

It should also be noted that, compared with the aforementioned document WO-A-00/65722, the invention is distinguished by the fact that the digital to analogue converter directly receives the initial digital signal in an initial frequency band. On the other hand, in the document WO-A-00/65722, the digital signal received by the converter already comprises a plurality of mirror bands. According to the invention, the absence of processing of the digital signal therefore simplifies the device for implementing the method, The initial frequency band can then lie between 2 and 30 MHz in order to obtain mirror bands at the output of the digital to analogue converter. In addition, the signal comprising the filtered band can be transmitted directly without requiring a mixer.

Advantageously, the method according to invention comprises a supplementary step that consists of increasing the sampling frequency of the digital signal. According to this embodiment, a supersampling is carried out at the output of the digital to analogue converter rather than at the input of this converter as in the aforementioned document.

Increasing the sampling frequency makes it possible to obtain an analogue signal containing more information, which improves the quality of the analogue signals. In addition, the method preferably comprises a supplementary step of amplifying said modified analogue signal.

Thus the modified analogue signal transmitted will be captured more easily by a reception apparatus.

In the context of this embodiment, provision is advantageously made for implementing a supplementary filtering step in order to eliminate any undesirable signals generated during the signal amplification step.

In the context of a first embodiment that will be described and illustrated hereinafter, provision is made for the sampling frequency to be 64 MHz.

A sampling frequency of 64 MHz allows the use of the first mirror band in addition to the initial band since the resulting spectrum then uses frequencies below 64 MHz. These frequencies are available on the coaxial cable for a television programme broadcasting application in the region involved.

Provision is thus preferably made for the initial frequency band to be between 2 and 30 MHz. In this way, the condition between the sampling frequency and the upper limit of the initial frequency band is fully complied with.

In the context of an advantageous implementation of the invention, said predetermined frequency band is between 34 and 62 MHz. According to the invention, this frequency band corresponds to the first mirror frequency band for an initial frequency band of between 2 and 30 MHz.

This first mirror frequency band has the advantage of being of good quality and allows satisfactory transmission.

The invention also relates to a method of transmitting a digital signal in an initial frequency band, said digital signal being sampled at a sampling frequency from an analogue signal having a frequency spectrum comprising at least one mirror frequency band, said mirror frequency band being an image of said initial frequency band with respect to at least one whole multiple of half said sampling frequency, said method comprising steps consisting of:
filtering said analogue signal in a predetermined frequency band among said at least one mirror frequency band so as to generate a modified analogue to signal having a spectrum in the said predetermined frequency band;
converting said modified analogue signal into a digital signal by means of an analogue to digital converter, so as to generate a digital signal in said initial frequency band;
transmitting said digital signal.

In this way, by spectral aliasing during the analogue to digital conversion, a digital signal is obtained in the initial frequency band.

Thus implemented, the method of receiving and processing an image analogue signal makes it possible, from a spectrum containing only one band, and what is more which is a mirror band, to recover a digital signal substantially identical to the one that could be obtained from the base band of an analogue signal.

In the context of an advantageous embodiment, a supplementary step is provided of amplification of the image signal before conversion of the image signal into a digital signal.

This is because it may happen that the analogue signal received is too weak to be able to be processed. Thus the supplementary step of amplifying the signal makes it possible to ensure a better quality of converted digital signal.

For the same reasons of obtaining a good-quality converted digital signal, a supplementary step of filtering is provided after the amplification step, with a supplementary filtering step eliminating all the undesired signals, such as for example the noise generated by the amplifier.

The invention also concerns a device for transmitting an analogue signal in a frequency band predetermined from an initial digital signal sampled at a sampling frequency, said device comprising:
transmission means;
a digital to analogue converter;
the transmission means being arranged to transmit the initial digital signal to the digital to analogue converter, said initial signal having an initial spectrum in an initial frequency band,
the digital to analogue converter being able to convert said initial digital signal into an initial analogue signal having a spectrum comprising a plurality of mirror frequency bands, said mirror frequency bands being images of said initial frequency band with respect to whole multiples of half the sampling frequency,
means of modifying the initial analogue signal arranged so as to generate a modified analogue signal having a modified spectrum in said predetermined frequency band;
means of transmitting the modified analogue signal in said predetermined frequency band,
   in which said modification means comprise a filter arranged to select predetermined frequency bands among said plurality of mirror frequency bands.

In the context of a preferred embodiment that will be described and illustrated hereinafter, provision is made for the converter of the digital signal into an analogue signal to comprise an interpolation filter increasing the sampling frequency of the digital signal in order to convert it into an analogue signal.

The advantages of such an interpolation filter were presented above.

Preferentially, the converter of the device according to the invention offers an analogue bandwidth of at least the maximum frequency of the mirror frequency band used of the highest order. In this way, several mirror image bands can be generated by the converter, and the device thus produced offers a greater choice of free frequency ranges at which the signals can be transmitted to the medium.

For the reasons disclosed above in the context of the method of processing and sending a signal according to the invention, provision is made for the device to advantageously comprise an amplifier of the analogue signal.

In addition and preferably, the device in this case comprises a supplementary filter for eliminating undesired signals generated by the amplifier.

The invention also concerns a device for transmitting a digital signal in an initial frequency band, said digital signal being sampled at a sampling frequency from an analogue having a frequency spectrum comprising at least one mirror frequency band, said mirror frequency band being an image of said initial frequency band with respect to at least one whole multiple of half said sampling frequency, said device comprising:
a filter arranged to select said analogue signal in a predetermined frequency band among said at least one mirror frequency band so as to generate a modified analogue signal having a spectrum in said predetermined frequency band;
an analogue to digital converter arranged to convert said analogue signal into a digital signal so as to generate a digital signal in said initial frequency band;
means of transmitting said digital signal.

Several embodiments of the device according to the invention will now be described with reference to the accompanying drawings, among which:

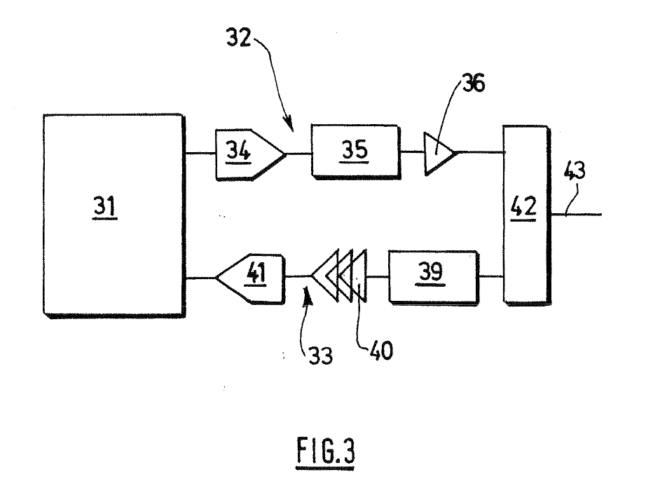

FIG. 3 is a diagram of an embodiment of a device according to the invention,

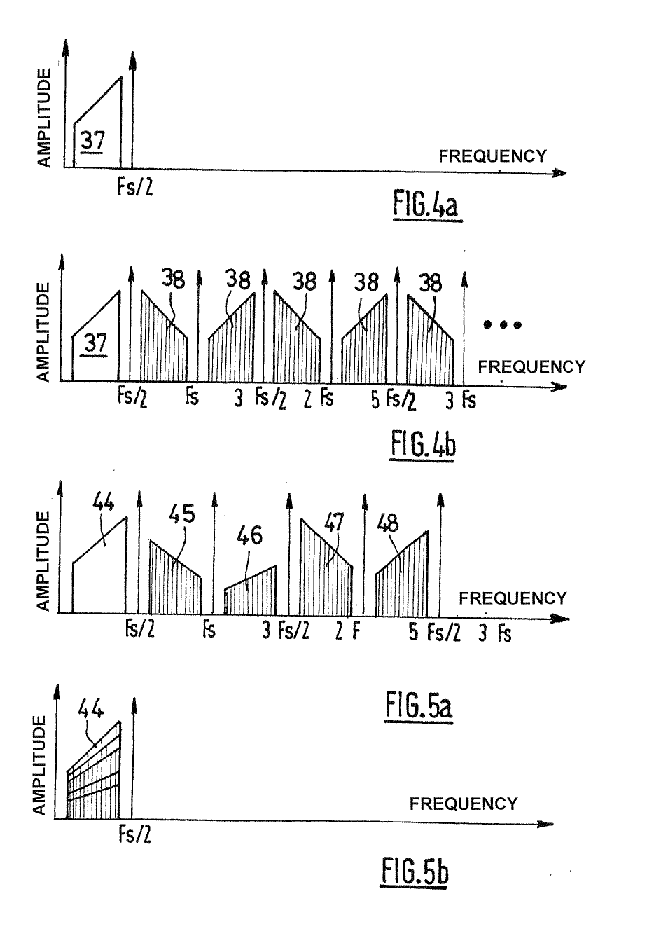

FIG. 4a illustrates a spectrum comprising a digital signal band before conversion into an analogue signal to be transmitted to a medium by means of the device shown in FIG. 3,

FIG. 4b shows a spectrum comprising an analogue signal band and its mirror bands generated by the digital to analogue converter (DAC) by conversion of the signal,

FIG. 5a shows a spectrum comprising an analogue signal band and its mirror bands transmitted via a medium to the device according to the invention,

FIG. 5b shows the spectrum of FIG. 5a aliased by conversion of the analogue signal into a digital signal by the analogue to digital converter (ADC),

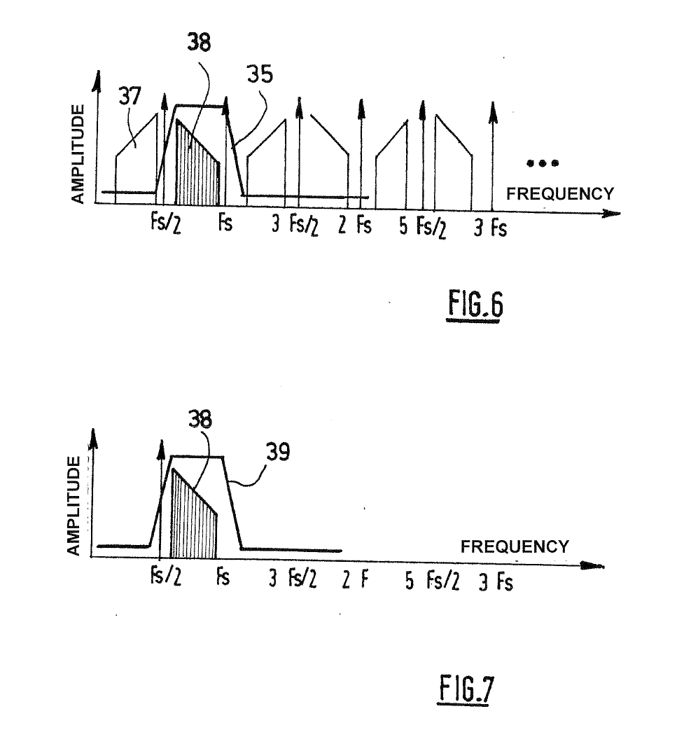

FIG. 6 shows the spectrum of an analogue signal band and its image bands on which a filter selecting an image band is placed, and more particularly a filter selecting the first image band generated by the conversion of the digital signal into an analogue signal,

and FIG. 7 shows the spectrum of an image band of an analogue signal that is to be converted into a digital signal, on which a filter is placed so as to generate the initial signal of FIG. 4a by spectral aliasing.

Reference will be made first of all to FIG. 3, which illustrates schematically an arrangement of various elements making up a device according to an embodiment in accordance with the invention.

The device in FIG. 3 comprises a modem 31, also referred to as a base-band circuit, comprising supply interfaces and means of processing a digital signal transmitted by the interfaces.

The modem 31 is connected to an emission chain 32 that comprises electronic elements for processing the signal in sending mode.

The modem 31 is also connected to a reception chain 33 comprising electronic elements for processing the signal in reception mode.

The sending chain comprises a converter 34 converting the digital signal into an analogue signal (DAC), a first filter 35 and a signal amplifier 36.

To simplify reading, the converter for converting a digital signal into an analogue signal will hereinafter be designated DAC.

The DAC complies with Shannon's law, which specifies the lack of determination existing between the frequency spectra situated on each side of a whole multiple of half the sampling frequency of the signal Fs.

In other words, the output analogue spectrum (shown in FIG. 4b) consists of the spectrum 37 corresponding to the incoming digital data (shown in FIG. 4a) and this same spectrum symmetrical about a whole multiple of half the sampling frequency Fs.

There is then obtained at the output of the converter a spectrum comprising an initial signal base band 37 corresponding to the incoming digital data, and mirror bands 38 corresponding to the images of the spectrum and its symmetries about the whole multiple of half the sampling frequency Fs.

In the context of the embodiment now described, the sampling frequency chosen is 64 MHz, and the useful frequency band is between 2 MHz and 30 MHz for the reasons mentioned above.

Thus the various mirror bands generated by the converter are present around a whole multiple of 32 MHz (64 MHz, 96 MHz, 128 MHz . . . ). In other words, the first mirror band is situated in a range of frequencies between 32 and 64 MHz, the second mirror band lies in a range of frequencies from 64 to 96 MHz, the fourth mirror band is situated in a range of frequencies between 96 and 128 MHz, and so on.

The DAC 34 advantageously comprises an interpolation filter that increases the sampling frequency of the digital signal in order to convert it into an analogue signal, so as to mitigate any attenuation of the spectrum. This is because it turns out that the spectrum comprising the mirror bands that are generated by a DAC is attenuated. Thus, in order to better use the information in the mirror band 38, an interpolation filter is used with a sampling frequency greater than Fs.

Provision is also made for the converter to offer an analogue bandwidth of at least 80 MHz so as to be able to process fairly wide signal bands or so as to be able to choose between the initial frequency band and the first mirror frequency band.

The filter 35 is a bandpass filter that makes it possible to select a single mirror band 38 according to the frequency range at which it has been decided to transmit said signal.

FIG. 6 illustrates schematically the selection of the first mirror band 38 by the filter 35.

The filter 35 has a bandwidth, the width of which is substantially identical to that of the predetermined mirror band 38 and the limits of the frequency range of which are substantially identical to those of the predetermined mirror band 38.

The reception chain 33 of the device illustrated in FIG. 3 comprises a second filter 39 for selecting a predetermined frequency band, an amplifier 40 for amplifying the signal and a converter for converting the analogue signal into a digital signal 41 (ADC).

The converter for converting an analogue signal into a digital signal will henceforth be referred to as ADC in order to simplify reading.

The sending 32 and receiving 33 chains are assembled with coupling means 42 that are connected to a signal transmission medium 43.

In reception mode, the filter 39 is also a bandpass filter. It is calibrated according to the frequency range of the mirror band containing the signal information to be converted in digital format.

To do this, the filter 39 has a bandwidth the width of which is substantially identical to that of the predetermined mirror band 38, as can be seen FIG. 7, and the limits of the frequency range of which are substantially identical to those of the predetermined mirror band 38.

In general terms, a converter for converting an analogue signal into a digital signal has initially an analogue signal spectrum that comprises the incoming analogue signal band superimposed on the mirror bands of the analogue spectre symmetrical about a whole multiple of half the sampling frequency. FIG. 5a shows the incoming analogue spectrum, comprising a base band 44 the signal of which is analogue, and its mirror bands 45, 46, 47 and 48. The mirror bands have been shown intentionally with different amplitudes so as best to display the superimposition of the bands by the converter, this superimposition being shown in FIG. 5b.

For the superimposition to be correctly formed by the ADC, the latter is calibrated with a sampling frequency equal to Fs.

The superimposition of the mirror band on the base band results from the signal processing formulae (also referred to as Shannon's law), which specify the spectral indetermination around a whole multiple of Fs/2.

In the context of the present invention, the analogue signal spectrum entering the ADC 41 includes only the mirror band 38 shown in FIG. 7.

Through spectral aliasing, an output spectrum is obtained consisting of the mirror band 38 moved to a frequency lower than Fs/2 in accordance with Shannon's law.

The signal of the mirror band 38 has been converted into a digital signal and corresponds to the initial digital signal.

In addition a supplementary filter can be provided in the sending chain in order to eliminate any undesired signals after amplification.

Likewise, a supplementary filter could be provided in the reception chain, after amplification of the signal.

These supplementary filters have not been shown in FIG. 3 in order to facilitate reading thereof. It should however be noted that these filters improve the quality of the signal to be processed.

The methods of processing the signals in order to transmit them or to process them on reception will now be detailed.

The modem 31 (or base-band circuit) transmits to the DAC 34 a digital signal coming from an electronic apparatus connected to the modem 38 via the modem interfaces.

This initial digital signal is contained in a frequency band (or base band) 37 that lies in an initial frequency range.

The DAC 34 converts the digital signal of the base band 37 into an analogue signal and creates mirror bands 38 that are spread over frequency ranges different from the frequency range of the base band 37. These different frequency ranges are all multiples of half the sampling frequency in accordance with Shannon's law.

The DAC 34 comprises an interpolation filter that increases the sampling frequency of the digital signal so as to obtain image bands 38 the analogue signal of which is more precise.

By means of the filter 35, a mirror band 38 is selected among all those that were generated by said converter.

The frequency band at which the mirror band is situated is the frequency band previously chosen to transmit the signal.

Preferably, this frequency band is different from the one normally used, so as to improve the global throughput via the medium 43.

To make this selection, a filter 35 was chosen according to its bandwidth.

In the context of the present example, it is chosen to transmit the signal at a frequency of less than 65 MHz, the frequencies above 65 MHz being available to transmit signals relating to television programmes for example.

A spectrum is then obtained containing only the image band 38, which is spread over a frequency range below 65 MHz and which comprises a signal that is an image of the analogue signal corresponding to the initial digital signal that was transmitted to the DAC 34.

The signal of the mirror band 38 is then amplified by means of the amplifier 36, and then the spectrum is filtered in order to remove all the undesired signals generated by the amplifier.

The image signal is then conveyed via said medium 43 as far as a signal transmission network, which will transmit it to an apparatus equipped with the device according to the invention able to process the analogue signal of the image band.

In reception mode, the spectrum coming from the medium is filtered by the filter 39 so as to select only the frequency range over which the mirror band 38 extends (FIG. 7).

The signal of the mirror band 38 is then amplified by means of the amplifier 40 and this spectrum is possibly filtered once again in order to remove all the undesired signals generated by the amplifier.

In this way, only the analogue signal is then converted into a digital signal by means of the ADC.

By spectral aliasing, there is then obtained a digital signal corresponding to an initial signal, sent by an electronic apparatus, and then transformed and transmitted by a device according to the invention.

The digital signal thus converted can then be transmitted to the electronic apparatus connected to the modem 34.

1. A method for transmitting and analogue signal in a frequency band predetermined from an initial digital signal sampled at a sampling frequency, said method comprising steps in which:
A digital to analogue converter (34) receives the initial digital signal, said initial digital signal having an initial spectrum in an initial frequency band,
the digital to analogue converter converts the initial digital signal into an initial analogue signal having a spectrum comprising a plurality of mirror frequency bands, said mirror frequency bands being images of said initial frequency band with respect to whole multiples of half the sampling frequency,
the initial analogue signal is modified so as to generate a modified analogue signal having a modified spectrum in said predetermined frequency band,
the analogue signal modified in the predetermined frequency band is transmitted,
characterized in that the step in which the initial analogue signal is modified comprises a filtering step consisting of filtering said predetermined frequency band among said plurality of mirror frequency bands.

2. A method according to claim 1, characterized in that it comprises a supplementary step of increasing the sampling frequency of the initial digital signal.

3. A method according to claim 1 or claim 2, characterized in that it comprises a supplementary step of amplifying the modified analogue signal.

4. A method according to claim 3, characterizing that it comprises a supplementary filtering step for eliminating undesirable signals generated during the step of amplifying the modified analogue signal.

5. A method according to claim 1, characterized in that said sampling frequency (Fs) is 64 MHz.

6. A method according to claim 1, characterizing that said initial frequency band (37) is between 2 and 30 MHz.

7. A method according to claim 1, characterized in that said predetermined frequency band is between 32 and 64 MHz.

8. A method of transmitting a digital signal in an initial frequency band, said digital signal being sampled at a sampling frequency from an analogue signal having a frequency spectrum comprising of at least one mirror frequency band, said mirror frequency band being an image of said initial frequency band with respect to at least one whole multiple of half said sampling frequency, said method comprising steps consisting of:
filtering said analogue signal in a predetermined frequency band among said at least one mirror frequency band so as to generate a modified analogue signal having a spectrum in said predetermined frequency band;
converting, by means of an analogue to digital converter, said modified analogue signal into a digital signal, so as to generate said digital signal in said initial frequency band;
transmitting said digital signal.

9. A method according to claim 8, characterized in that it comprises a supplementary step of amplifying the modified analogue signal before conversion of the modified analogue signal into a digital signal.

10. A method according to claim 9, characterized in that it comprises a supplementary filtering step after the amplification step, said supplementary filtering step eliminating all the undesired signals.

11. A device for transmitting an analogue signal in a frequency band predetermined from an initial digital signal sampled at a sampling frequency, said device comprising;
transmission means (31);
a digital to analogue converter (34);
the transmission means being arranged to transmit the initial digital signal to the digital to analogue converter, said initial digital signal having an initial spectrum in an initial frequency band,
the digital to analogue converter (34) being able to convert said initial digital signal into an initial analogue signal having a spectrum comprising a plurality of mirror frequency bands, said mirror frequency bands being images of said initial frequency band with respect to whole multiples of half the sampling frequency,
means (35) of modifying the initial analogue signal arranged so as to generate a modified analogue signal having a modified spectrum in said predetermined frequency band,
means of transmitting the modified analogue signal in said predetermined frequency band,
characterizing that said modification means (35) comprise a filter arranged to select said predetermined frequency band from said plurality of mirror frequency bands.

12. A device according to claim 11, in which said initial frequency band (37) is between 2 and 30 MHz.

13. A device according to claim 11 or 12, characterized in that said converter for converting the digital signal into an analogue signal (34) comprises an interpolation filter increasing the sampling frequency of the digital signal in order to convert it into an analogue signal.

14. A device according to any one of claims 11 to 13, characterized in that it also comprises an amplifier (36) for the analogue signal.

15. A device according to claim 11 or 12, characterized in that it comprises a supplementary filter for eliminating undesired signals generated by said amplifier.

16. A device for transmitting a digital signal in an initial frequency band, said digital signal being sampled at a sampling frequency from an analogue signal having a frequency spectrum comprising at least one mirror frequency band, said mirror frequency band being an image of said initial frequency band with respect to at least one whole multiple of half said sampling frequency, said device comprising:
a filter (39) arranged to select said analogue signal in a frequency band predetermined among said at least one mirror frequency band so as to generate a modified analogue signal having a spectrum in said predetermined frequency band;
an analogue to digital converter (41) able to convert said analogue signal into a digital signal, so as to generate a digital signal in said initial frequency band;
means (31) of transmitting said digital signal.

17. A device according to claim 16, characterized in that it also comprises an amplifier (40) for the modified analogue signal.

18. A device according to claim 17, characterized in that it comprises a supplementary filter for eliminating undesired signals generated by said amplifier.
